(19) United States
(12) Patent Application Publication
(10) Pub. No.: US 2008/0301433 A1
(43) Pub. Date: Dec. 4, 2008

(54) Secure Communications

(75) Inventor: Stephane Di Vito, Ciotate (FR)

Correspondence Address: FISH & RICHARDSON P.C., PO BOX 1022, MINNEAPOLIS, MN, 55440-1022, US

(73) Assignee: ATMEL CORPORATION, San Jose, CA (US)

(21) Appl. No.: 11/755,544

(22) Filed: May 30, 2007

(51) Int. Cl. G06F 17/00; H04K 1/00; H04L 9/14; H04L 9/32

(52) U.S. Cl. 713/153; 380/44; 713/168; 726/14; 726/5

(57) ABSTRACT

The subject matter of this specification can be embodied in, among other things, an apparatus that includes a verification module to provide information used to identify a user of the apparatus, a memory for storing information used for securing communications transmitted to a remote device, a processing unit for generating a secured communication based on the stored information, and an interface to communicate with a peripheral interface of a host device. The host device configured to transmit the secured communication to the remote device without accessing content of the secured communication.

### TECHNICAL FIELD

The present invention relates to the secure exchange of information.

### BACKGROUND

Security devices can be used in electronic verification, such as authenticating users, verifying the authenticity of software, or logging on to computer systems. Security devices may come in different form factors including USB dongles, smart cards, software tokens stored on media, and PC cards. The security devices can include information used to communicate with other systems. For example, a user may use a USB dongle inserted into a personal computer to verify his identity when logging on to a bank's web server. Because information stored within a security device may be critical to electronic verification, it may be difficult to transmit or modify the information without exposing it.

### SUMMARY

In general, this specification describes secure communications.

In a first general aspect, an apparatus is described. The apparatus includes a verification module to provide information used to identify a user of the apparatus, a memory for storing information used for securing communications transmitted to a remote device, a processing unit for generating a secured communication based on the stored information, and an interface to communicate with a peripheral interface of a host device. The host device configured to transmit the secured communication to the remote device without accessing content of the secured communication.

In a second general aspect, a method is described. The method includes providing information used to verify a user associated with a security device, generating, at the security device, information for securing communications between the security device and a remote device, and transmitting, using a peripheral interface, a secure communication to a host device having a bridge application configured to forward the secure communication to the remote device using a network, wherein content of the secure communication is inaccessible to the host device.

In another general aspect, a method is described that includes providing information used to verify a user associated with a security device, receiving at a local device from a security device a secure communication transmitted through a local connection of the local device, wherein content of the secure communication is inaccessible to the local device, and forwarding, through an unsecured network, the secure communication to a remote secure device configured to access the content of the secure communication.

In yet another general aspect, a system is described that includes a security information generator for determining information used to secure messages transmitted to a remote device, a message generator for generating secure messages using the determined information, and an interface to communicate with a peripheral interface of a host device configured to transmit the secure messages to the remote device, wherein content of the secured messages are inaccessible to the host device.

In another aspect, a system is described that includes means for generating secure communications at a peripheral for transmission through an unsecured local device to a remote device. The system also includes an interface means for transmitting the secure communications to the unsecured local device, wherein content of the secure communications are inaccessible to the unsecured local device.

In yet another general aspect, a method is described that includes generating information for securing communications between a security device and a remote device and transmitting the generated information to a host device using a peripheral connection. The host device is coupled to the remote device without making the generated information accessible to the host device.

The systems and techniques described here may provide none, one, or more of the following advantages. Secure communications may be achieved where only a security device and a remote device are trusted. The local device used to forward information to the remote device and the network used for the transmission may be unsecured while still maintaining the confidentiality of the communications between the security device and the remote device. Attacks on the communication transmission, such as man-in-the-middle attacks, packet content sniffing, etc., can be avoided. Additionally, information stored on a security device, such as encryption or digital signature keys, can be updated in a secure manner.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a schematic diagram depicting an example of a system for communicating remotely with security devices over non-trusted networks.

FIG. 2 is a schematic diagram of a system depicting an implementation of secure data transmission.

FIG. 3 is a flow chart depicting an example of a method for communicating remotely with security devices over non-trusted networks.

FIG. 4 is a sequence diagram depicting an example of interactions between a secure server and a security device over a secure channel.

FIG. 5 is a sequence diagram depicting an example of interactions between a secure server, a non-secure client, and a security device.

FIG. 6 is a diagram of an exemplary computer system.

### DETAILED DESCRIPTION

This document describes implementations of systems and methods for establishing a secure communication over non-secure networks, between a remote device and a security device. Examples of security devices can include a USB cryptographic key, a smart card, or a software token stored on a computer peripheral device the includes a software token. Other forms of security devices are possible. In certain implementations, the security device is connected to a client and can communicate with a server over a network, such as a non-trusted network. Additionally, the security device and the server may establish a secure channel for communication using administrative keys. Establishing the secure channel may permit communication between the server and the security device with limited additional security in place. For example, the client to which the security device is connected may be unsecured, or non-trusted without compromising the secure communication between the security device and the server.

In some implementations, the described systems and methods can be used to remotely manage security devices. For example, the secure channel can be used to update information included in the security device, such as encryption keys, authentication keys, identifiers, semi-static stored information, information used to generate encryption and authentication keys, etc.

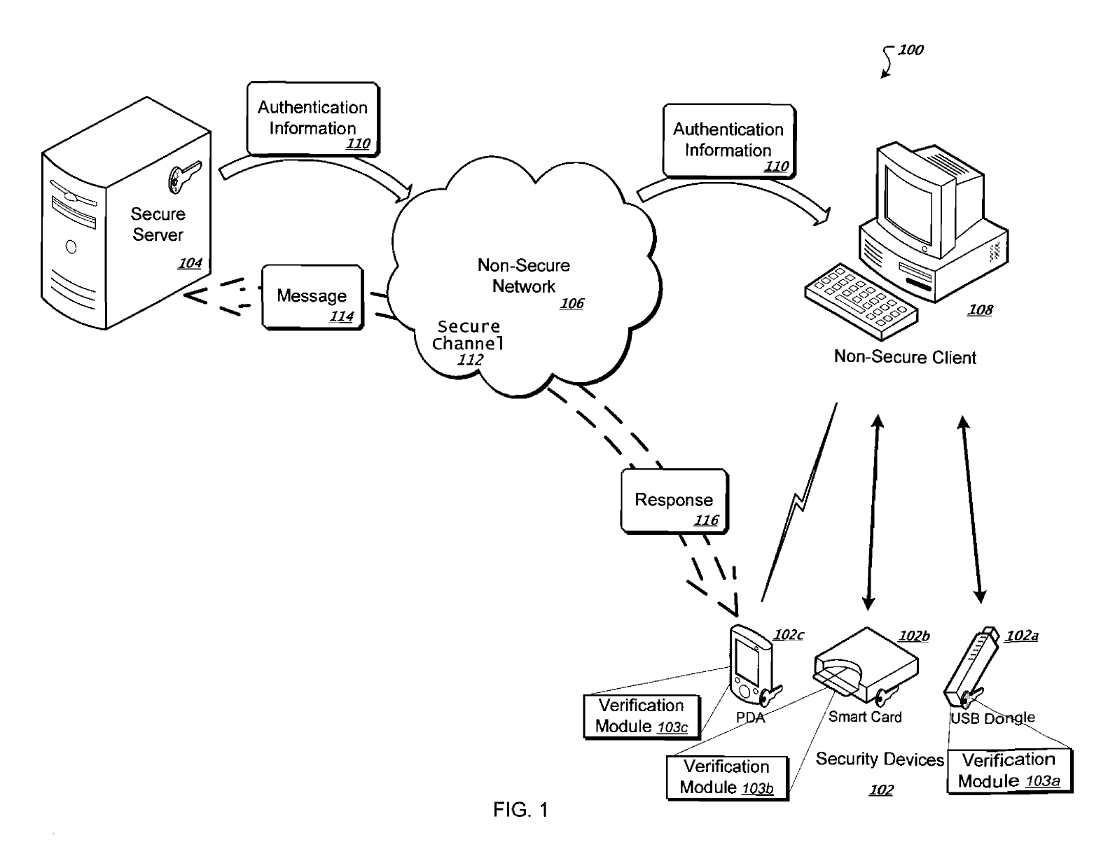

FIG. 1 is a schematic diagram depicting an exemplary system 100 for remote communication with a security device 102 over non-secure networks. In the implementation of FIG. 1, the system 100 includes a secure server 104, which communicates with one or more of the security devices 102 through a non-secure network 106, for example, the Internet. The secure server 104 communications can be transmitted or received by a non-secure client machine 108 on behalf of the security device 102. The security devices 102 can be connected to the non-secure client machine 108 wirelessly, such as through Bluetooth, or directly, such as through a Universal Serial Bus (USB) connection. Examples of security devices 102 can include a USB Dongle 102a, a Smart Card 102b, or a PDA 102c, as shown in FIG. 1.

Secure servers 104 and security devices 102 may reside in a controlled environment, with limited access to the private information which they store, send, or receive, process, etc. Access to a security device 102 may be physically restricted or electronically restricted. For example, physically securing a device can include restricting physical access to the device and only transmitting or receiving information through a physical connection to the device. Electronically securing a device can include restricting access to the device by requiring login and password information, requiring communication stored or processed by the device to be encrypted or digitally signed, locating the secured device 102 behind a firewall that restricts communications, etc.

Under certain conditions, limiting or restricting access to some system components, such as applications, networks, or devices, may not be possible if the components are not under the control of a user (e.g. the public Internet). In such cases, portions of the systems may be untrusted or unsecured. Unsecured devices can be vulnerable to problems such as information theft. Additionally, unsecured devices can be vulnerable to attacks from malicious users, software viruses, spyware, adware, and key-logging software, for example.

In certain implementations, establishing secured communications between the security device 102 and the secure server 104 may permit the use of unsecured clients because the securing of communications is performed on the security device 102 (or the server 104) instead of at the client where the communication could be altered or accessed. Additionally, in certain implementations, establishing layers of security (e.g., using encryption, digital signatures) directly between the security device 102 and the secure server 104 permits the use of public, or unsecured networks, for transmission of the communications because at least one layer of security exists, even if the network is compromised.

Upon establishing communication between the security device 102 and the client 108, the secure server 104 can form a secure channel 112, which can be used to communicate with the security device 102. In some implementations, the secure server 104 can exchange encrypted and signed messages with a security device 102, where the encryption and authentication is based on keys known to both the secure server 104 and the security device 102.

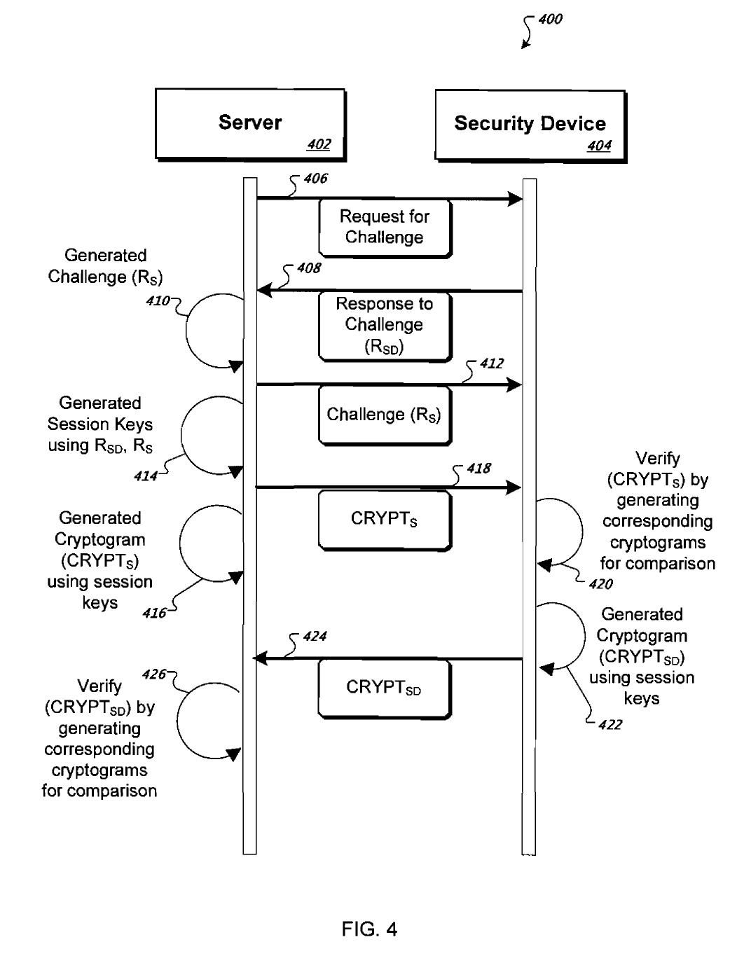

In one implementation of establishing a secure channel, the secure server 104 builds a message 114, which it signs and encrypts. Then the encrypted and signed message 114 can be transmitted to the security device 102. The security device 102 can prepare a response 116 to the message 114 using information contained in the message 114 sent by the secure server 104. The response 116 also can be signed and encrypted before transmission to the secure server 104. In some implementations, session keys for additional secure communications can be generated using the message 114 and response 116 with the static keys stored on the server 104 and the security device 102. The session keys can enable establishment of a secure channel 112, which is described in greater detail in association with FIG. 4.

In certain implementations, after a secure channel 112 is established, the secure server 104 can generate messages, such as application protocol data unit (APDU) messages 114, and send them to the non-secure client machine 108 using a network protocol such as hypertext transfer protocol (HTTP), over the non-secure network 106. The non-secure client machine 108 can include software to send the APDU message 114 to the security device 102. In the example of FIG. 1, the non-secure client machine 108 can function as a gateway that forwards communications to and from the security device 102. Functioning as a gateway can include facilitating communication between the secure server 104 and the security device 102 by providing a user interface, HTTP communications, and/or TCP/IP communications, for example.

Although, the network 106 and client 108 are described as unsecured, in other implementations, they may be secure. For example, the network 106 may be a privately controlled intranet and the client may be a node on the intranet with restraints placed on users that may access the node.

In certain implementations, the security device 102 also includes a verification module 103. The verification module can be used to verify a user associated with the security device. For example, software may be installed on the non-secure client machine 108, where the software is only operable when (or after) the security device 102 is inserted into a USB port of the client machine 108.

In certain implementations, the verification module 103 can generate verification information that is used to verify that the user associated with the security device (e.g., the person who inserted the security device into the USB port of the client machine 108) is authorized to use the software. For example, the verification information may be a cryptographic key that is transmitted to an application on the non-secure client machine 108. The application can use the key to determine if the key is associated with an authorized user of the application, such as a licensee. If the key matches an authorized user, the application can unlock all or a portion of that application's functions for use by the user.

In other implementations, the verification module 103 can generate verification information that is used to verify that the user is authorized to login to a remote device (not shown), such as a web server for a banking institution. The verification module 103, in some implementations, can generate verification information that includes a unique identifier for a user associated with the device. The verification information can be transmitted to the non-secure client, which can forward the information to the remote device to which the user desires access.

For example, a user may use a public computer to navigate to a bank's web site, where he is prompted to connect his security device to the public computer in order to access his online banking statement. The user can connect his security device 102 to the public computer (e.g., by inserting a smart card issued by the bank into the public computer's smart card reader). The verification module 103 of the smart card can include software algorithms executed by a processor that access a unique identifier stored in a memory of the security device. The processor can transmit the unique identifier to the public computer, which transmits it to a web server hosting the bank's web site. The web server can use the unique identifier to verify that the user has an account at the bank and can then transmit a web page that includes the user's banking statement to the public computer. In certain implementations, the verification information transmitted to the non-secure client can be encrypted and digitally signed.

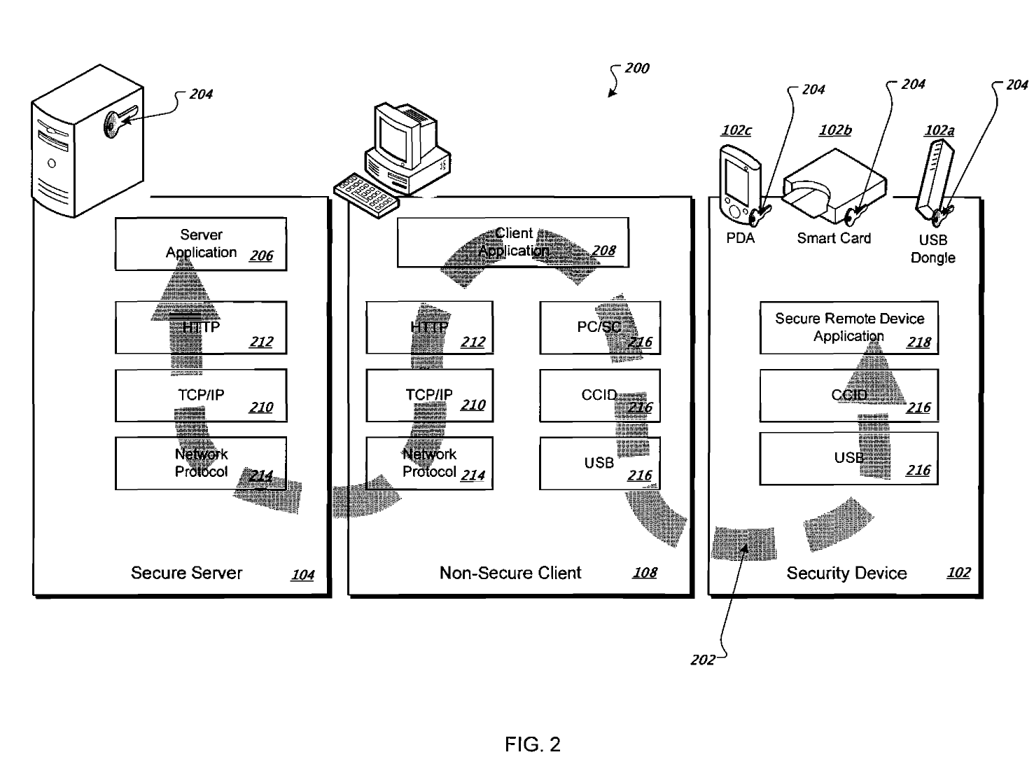

FIG. 2 is a schematic diagram of an example system 200 for transmitting secure communications from a secure server 104 to a security device 102. In this implementation, the secure server 104, the non-secure client 108, and the security device 102 are in communication via a secure channel 202. Communication between the secure server 104, and the security device 102 can be encrypted and decrypted, for example, using static keys 204. Static keys 204 can consist of information used in cryptographic and authentication operations.

In certain implementations, the static keys 204 can be created and shared between the secure server 104 and the security device 102 in a secured environment, such as during manufacturing. In some implementations, the static keys are permanently, or semi-permanently stored on the security device 102 and the secure server 104. Additionally, in some implementations, the static keys can be used to generate temporary keys such as session keys that can be used for a limited number of communication sessions between devices. For example, the static keys 204 can be secret keys, private keys, or a combination thereof. Secret keys can be used in encryption, including Advanced Encryption Standard (AES). Private keys can be encrypted using several algorithms, including Rivest, Shamir and Adleman (RSA) algorithms. In some implementations, the static keys 204 can also be used in digital signing of communications as well as for encryption.

In some implementations, the server 104, the non-secure client 108, the security device 102, or any combination thereof, can host applications used to transmit secure communications between the security device 102 and the secure server 104. For example, a server application 206 can remotely manage the security device by providing functions that initiate security device 102 updates. Additionally the server application 206 may perform verification or authentication functions, such as such as verification of software licensing, or storage and authentication of user credentials.

As shown in the implementation FIG. 2, the server application 206 can communicate with a client application 208 through one or several layers of protocol, some of which are depicted in FIG. 2. For example, the server application 206 can transmit information using application protocols, such as Hypertext Transfer Protocol (HTTP). The application protocols can be wrapped in additional protocols such as the transport protocol Transmission Control Protocol (TCP), and the networking protocol Internet Protocol (IP). These protocols can then in turn be wrapped in other protocols, such as the Ethernet protocol of the data link layer.

Note that in the example of FIG. 2, these additional protocols do not need additional security mechanisms to maintain secure communications between the security device 102 and the secure server 104. For instance, IPSec is not necessary to secure the communications. The secure communication is established in this example through the channel 202 previously established.

Communications from the secure server 104 to the security device 102 can be transferred through the non-secure client 108 using a client application 208. The client application 208 can function as a bridge application between the secure server 104 and the security device 102. In some implementations, the client application 208 forwards the communications between the secure server 104, and the security device 102 without encrypting/decrypting or signing/authenticating the messages. Instead, the messages can be forwarded without modification. Additionally, in some implementations, the non-secure client 108 may not have access to security information used to encrypt or sign the messages, and therefore may not be able to access or modify the messages.

The client application 208 can transfer the secured communications using device protocols 216, which are compatible with the security device 102. In some implementations, the protocols 216 can include Personal Computer/Smart Card (PC/SC) protocols, USB Chip/Smart Card Interface Devices (CCID) protocols, and Universal Serial Bus (USB) protocols, for example. Using the client application 208 to transfer information between the server application 206 and a security device application 218, the non-secure client can function as a forwarding element in the system 200.

In some implementations, security devices 102 can connect to a non-secure client 108 via a wired connection (e.g., USB) or wirelessly (e.g., Bluetooth). The security device 102 can include a security device application 218. The security device application 218 can transmit secure communications to the client application 208, which can transfer the communications to the server application 206. In some implementations, the security device application 218 can be updated, or modified for example, by the server application 206. For example, the server application 206 can transmit a request to modify the static keys 204 stored on the security device 102. One or more keys can be embedded in the secure communications transmitted to the security device 102. After receipt, the security device application 218 can decrypt and authenticate the communication before using the content of the communication to update the static keys 204.

In other implementations not shown in FIG. 2, alternative protocols between the server application 206 and the client application 208 may exist, including Internet Packet Exchange/Sequenced Packet Exchange (IPX/SPX), User Datagram Protocol (UDP), Internet Protocol Security (IPsec), Asynchronous Transfer Mode (ATM), etc.

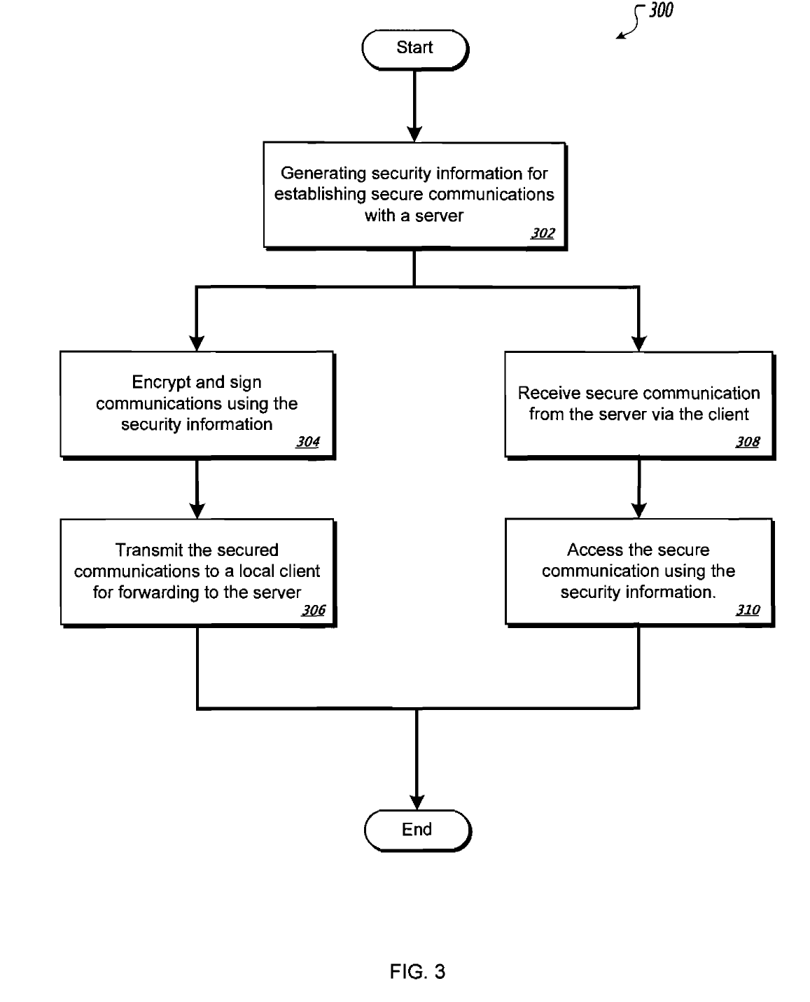

FIG. 3 is a flow chart depicting an example of a method 300 for communicating remotely with security devices over networks including non-secure networks. The method 300 may be performed, for example, by a system such as the systems 100 and 200. For clarity of presentation, the description that follows uses components of the systems 100 and 200 as the basis of an example for describing the method 300. However, another system, or combination of systems, may be used to perform the method 300.

As indicated in FIG. 3, the method 300 can include steps for receiving and sending secure communications. The method 300 begins with generating security information for establishing secure communications as indicated in step 302. For example, the security device 102 can generate security information such as session keys, derived from the static keys stored on both the secure server 104, and the security device 102.

The method 300 can include two branches, where one branch can include steps for transmitting secure communications, and another branch can include steps for receiving secure communications. The first step of the branch illustrating transmission of security information is step 304. In step 304, communications are encrypted and signed using the security information. For example, the security device application 218 may encrypt and sign communications using an encryption function stored in memory on the security device 102.

In step 306, communications are transmitted to a local client for forwarding to the secure server 104. For example, the security device 102 may transmit communications to a local client using the USB protocol through a direct physical connection, such as the coupling of a male USB receptor of the security device 102, to a female USB receptor of the client 108. After step 306, the method 300 can end.

The first step of the branch illustrating receiving security information is step 308. In step 308, secure communications are received from the server 104 via the client 108. For example, the security device 102 may receive communications via a wireless Bluetooth network connection. In one implementation, the next step of the branch illustrating receiving security information is step 310. In step 310, secure communications are accessed using the security information. For example, the security device application 218 can use security information, such as session keys, to decrypt the secured communications, and authenticate a signature that may be embedded in the communications. After step 310, the method 300 can end.

FIG. 4 is a sequence diagram depicting an example of interactions between a secure server 402 and a security device 404 over a secure channel. Once established, the secure channel can be used for communications between the secure device 404 and the server 402. For clarity of explanation, the non-secure client is omitted from the following descriptions. However, the non-secure client can act as a bridge to transfer and forward communications described between the server 402 and the secure device 404. In certain implementations, the secure channel can be established using static keys that are permanently (or semi-permanently) stored on both the security device 102 and the server 104. For example, the static keys can be shared during manufacturing of the security device 102 in a secure environment, such as over a secure network, or using a direct physical connection of the secure device 404 with the server 402.

The sequence 400 begins with a transmission 406 from the server 402 to the secure device 404, where the transmission includes a request that the secure device 404 transmit a challenge to the server 402. For example, the challenge can be a random series of numbers or alphanumeric characters. Arrow 408 indicates a transmission from the secure device 404 to the server 402, where the transmission includes a response to the challenge (R_{SD}).

Arrow 410 indicates the generation of a challenge (R_{SD}) by the server 402, which is transmitted from the server 402 to the secure device 404, as indicated by arrow 412. As indicated by arrow 414, the server 402 can generate session keys from the static keys and challenges generated by the secure server 104 and the security device 102.

In one implementation, the server may compute multiple session keys for authenticating and encrypting communications. For example,

K_{SM}=f(R_{S},R_{SD},K_{SIGN}),

can represent a session key used to digitally sign messages, where K_{SM} is the session key used for signing, R_{S} is a challenge response from the secure server 104, R_{SD} is the response from the security device 102, K_{SIGN} is a static key associated with digital signing functions for messages, and f is an encryption function performed on each parameter.

Additionally, the session key used for signing responses can be represented by

K_{SR}=f′(R_{S},R_{SD},K_{SIGN}),

where K_{SR} is the session key used for signing, R_{S} is a challenge response from the secure server 104, R_{SD} is the response from the security device 102, K_{SIGN} is a static key associated with digital signing functions for responses, and f′ is an encryption function performed on each parameter.

Another session key may be

K_{EM}=f(R_{S},R_{SD},K_{ENC}),

which can be used to encrypt messages, where K_{EM} is the session key used to encrypt messages, R_{S} is a challenge response from the secure server 104, R_{SD} is the response from the security device 102, K_{ENC} is a static key associated with encrypting messages, and f is an encryption function performed on each parameter. In certain implementations, the encryption function used to calculate K_{EM} is different from that used to calculate K_{SM} as described above.

The session key for encrypting responses may be expressed as

K_{ER}=f′(R_{S},R_{SD},K_{ENC}),

where K_{ER} is the session key used to encrypt responses, R_{S} is a challenge response from the secure server 104, R_{SD} is the response from the security device 102, K_{ENC} is a static key associated with encrypting responses, and f′ is an encryption function performed on each parameter. In certain implementations, the encryption function used to calculate K_{ER} is different from that used to calculate K_{SR} as described above.

Using the session keys, the server 402 can generate cryptograms as indicated by arrow 416. Arrow 418 indicates a transmission from the server 402 to the secure device 404, where the transmission includes a cryptogram, CRYPTS. For example, the cryptogram may be expressed as

CRYPT_{S}=Enc(K_{EM},f″(R_{SD},R_{S}),

Arrow 420 indicates the generation of complimentary cryptograms by the secure device 404 for comparison to cryptograms on the server 402. In some implementations, if the cryptogram is successfully verified by the security device 404 when compared with the cryptogram generated by the server 402, the security device 402 can generate its own cryptogram using sessions keys as indicated by arrow 422. For example, the cryptogram generated by the security device 102 can be expressed as

CRYPT_{SD}=Enc(K_{EM},f″(R_{S},R_{SD}),

where K_{EM} is the session key for message encryption, f″ is an encryption function performed on R_{S} and R_{SD} and Enc is an encryption function performed on the K_{EM} session key, and the result of the f″ encryption function. The functions used to generate the cryptograms can be different from functions used to encrypt other information, as described above.

Arrow 424 indicates the transmission of a cryptogram from the security device 404 to the server 402 and arrow 426 indicates the verification by the server 402 of the cryptogram sent during transmission 424. For example, the server can generate a complimentary cryptogram using session keys stored at the server and then can compare the complimentary cryptogram with CRYPT_{SD} to verify they match.

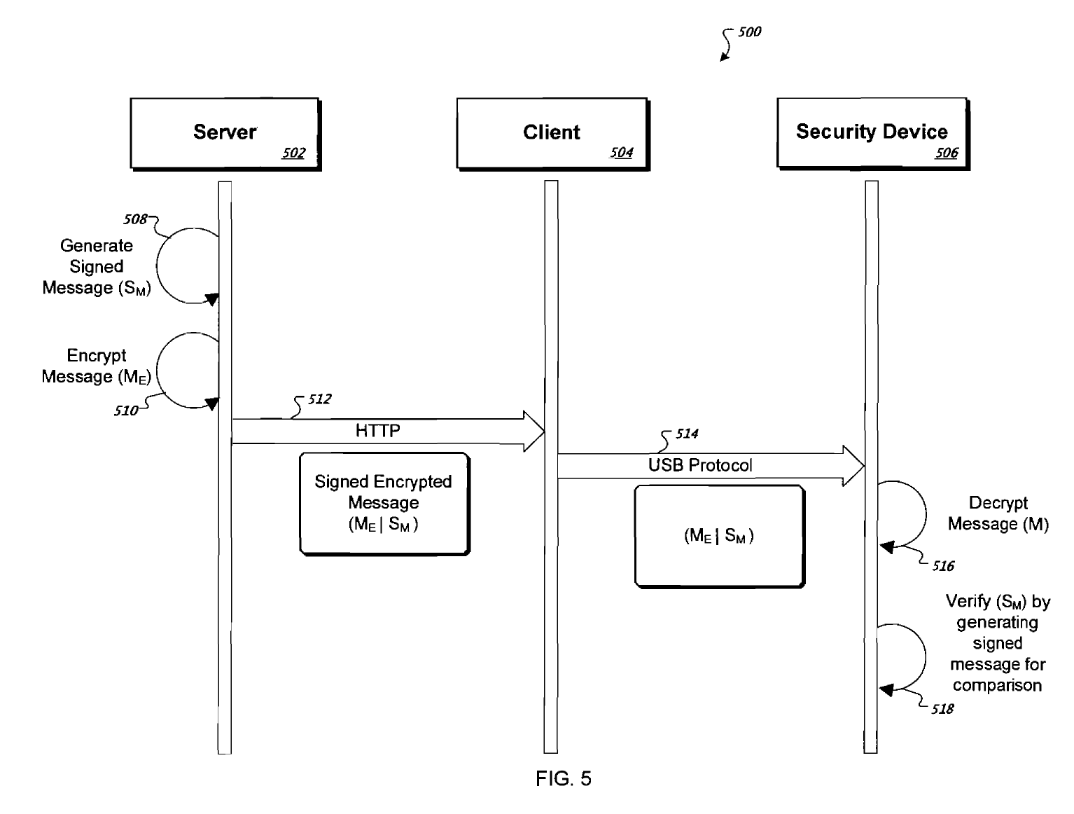

FIG. 5 is a sequence diagram 500 depicting an example of interactions between a secure server 502, a non-secure client 504, and a security device 506.

Arrow 508 indicates the generation of a signed message (S_{M}) by the server 502. A message can be signed using the session key K_{SM} and the resulting signature is S_{M}. The message and the S_{M} can be encrypted using the session key K_{EM}, as indicated by arrow 510, and the resulting message is M_{E}. The server 502 can transmit the signed and encrypted message to the non-secure client as indicated by arrow 512. In some implementations, the message can be transmitted using an unsecured protocol, such as HTTP. The non-secure client can include a bridge application, which can subsequently forward the signed, encrypted message (M_{E}|S_{M}) to a connected security device using the appropriate protocol.

Arrow 514 indicates the transmission of the signed, encrypted message (ME|SM) from the non-secure client 504 to the secure device 506 using the USB protocol. Although the example implementation demonstrates the use of the USB protocol, alternative protocols may be used such as, but not limited to, RS-232 serial protocols, RS-494 serial protocols, parallel port protocols, or wireless Bluetooth connections, for example.

Arrow 516 indicates the decryption of message M_{E} by the security device 506. For example, the security device 102 can use session key K_{EM} as described previously, to decrypt the message. The message can also be verified, as indicated by arrow 518. For example, the decrypted communication can include the message (M), as well as the digital signature (S_{M}). The security device 102 can use the session key K_{SM} to sign the received message (M) and then can compare the newly generated signed message with the received digital signature (S_{M}). If the signatures match, the message is authenticated (e.g., the security device has a guaranty that the message originated from the server) and is certified as unaltered.

FIG. 5 depicts a sequence diagram for the transmission of messages. The transmission, signing, and encryption of responses can be accomplished in a substantially similar way in some implementations.

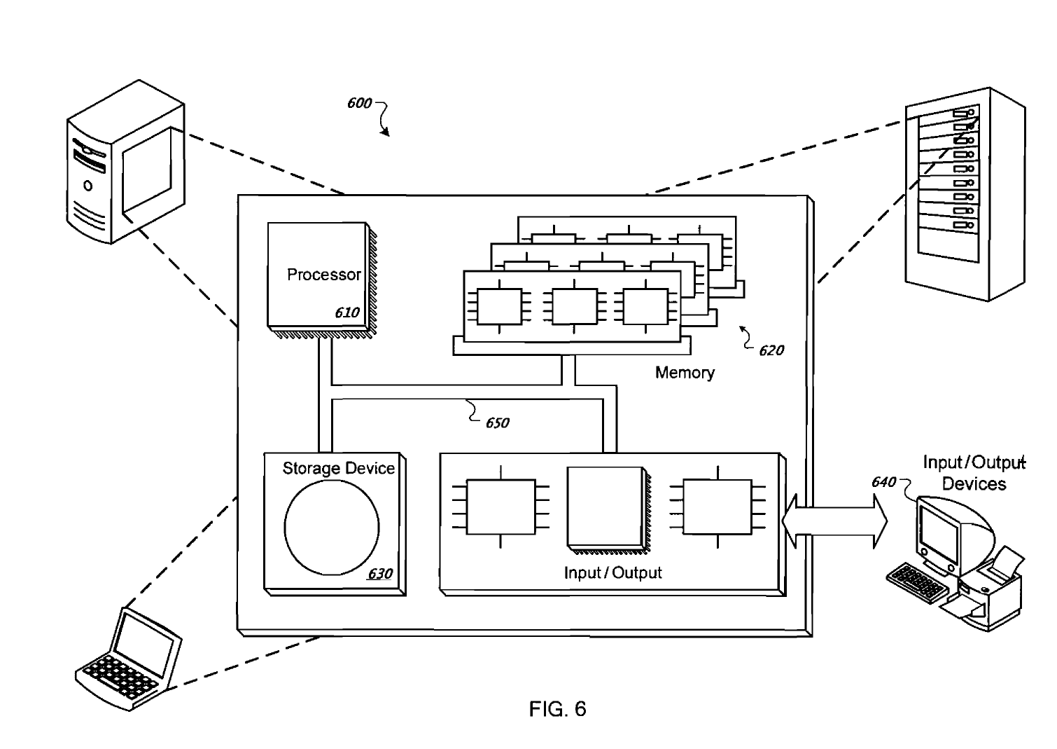

FIG. 6 is a diagram of an exemplary computer system. The system 600 can be used for the operations described in association with any of the methods described previously, according to one implementation. Additionally, the system 600 can be used to implement the client 108, the server 104, or the security device 102. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. In some implementations, the processor includes a secure microcontroller, such as the SecureAVR™, sold by ATMEL Corporation of San Jose, Calif. System components, such as the security device, can include the secure microcontroller, which may hinder or prevent the extraction of data from the component (e.g., the extraction of key information from the security device). In some implementations, the secure microcontroller can implement security features, such as environmental sensors that include temperature sensors, voltage sensors, light sensors, etc. The security features can also include counter measures, such as current consumption scrambling, random execution timings, etc.

Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. An apparatus comprising:
a verification module to provide information used to identify a user of the apparatus;
a memory for storing information used for securing communications transmitted to a remote device;
a processing unit for generating a secured communication based on the stored information; and
an interface to communicate with a peripheral interface of a host device, the host device configured to transmit the secured communication to the remote device without accessing content of the secured communication.

2. The apparatus of claim 1, wherein the user of the apparatus comprises a person associated with the apparatus.

3. The apparatus of claim 1, wherein the processing unit uses one of a digital signature or encryption in generating the secured communication.

4. The apparatus of claim 1, wherein the peripheral interface comprises a direct one-to-one connection with the host device.

5. The apparatus of claim 1, wherein the peripheral interface uses a wireless protocol.

6. The apparatus of claim 5, wherein the wireless protocol comprises a Bluetooth protocol, an IEEE 802 protocol, or a radio frequency protocol.

7. The apparatus of claim 1, wherein the apparatus is portable.

8. The apparatus of claim 1, wherein the peripheral interface uses a wired protocol.

9. The apparatus of claim 8, wherein the wired protocol comprises a USB protocol, an IEEE 1394 protocol, a serial RS-232 protocol, or a parallel interface protocol.

10. The apparatus of claim 1, wherein the stored information comprises one or more static keys used to secure communications.

11. The apparatus of claim 10, wherein generating the secured communication comprises generating one or more session keys based on the one or more static keys.

12. The apparatus of claim 11, wherein generating the secured communication further comprises encrypting or signing a communication using the one or more session keys.

13. The apparatus of claim 10, wherein at least a portion of the stored information used for securing communications is stored in the memory during one of manufacture or processing of the apparatus.

14. The apparatus of claim 1, wherein the transmission between the host device and the remote device is based on an unsecured protocol.

15. The apparatus of claim 14, wherein the unsecured protocol comprises unsecured TCP/IP or unsecured HTTP.

16. The apparatus of claim 1, wherein generating the secure communication based on the stored information comprises establishing a secure channel for transmission of communications to the remote device.

17. The apparatus of claim 16, wherein the processing unit establishes the secure channel in part by verifying one or more challenges or responses received from the remote device.

18. The apparatus of claim 17, wherein the processing unit uses the one or more verified challenges or verified responses to generate one or more session keys included in the stored information used for securing communications transmitted to the remote device.

19. The apparatus of claim 1, wherein the host device is unsecured.

20. A method comprising:
providing information used to verify a user associated with a security device;
generating, at the security device, information for securing communications between the security device and a remote device; and transmitting, using a peripheral interface, a secure communication to a host device having a bridge application configured to forward the secure communication to the remote device using a network, wherein content of the secure communication is inaccessible to the host device.

21. The method of claim 20, wherein the user to be verified is a person associated with the security device.

22. The method of claim 20, further comprising securing the secure communication.

23. The method of claim 22, wherein securing the secure communication comprises using one of a digital signature or encryption.

24. The method of claim 20, further comprising establishing a connection with the peripheral interface using a wireless protocol.

25. The method of claim 20, wherein the security device is portable.

26. The method of claim 20, further comprising establishing a connection with the peripheral interface using a wired protocol.

27. The method of claim 20, wherein generating the information for securing communications comprises generating one or more session keys used to secure a communication.

28. The method of claim 27, further comprising generating the one or more session keys using one or more static keys stored at the security device.

29. The method of claim 28, further comprising storing the one or more static keys at the security device during one of manufacture or processing of the security device.

30. The method of claim 20, further comprising using an unsecured protocol to transmit the secure communication over the network from the host device to the remote device.

31. The method of claim 20, further comprising establishing a secure channel for transmission between the security device and the remote device.

32. The method of claim 31, wherein establishing the secure channel comprises verifying one or more challenges or responses transmitted between the security device and the remote device.

33. The method of claim 32, wherein the one or more challenges or responses are used to generate one or more session keys included in the information used to secure the communications between the security device and the remote device.

34. A method comprising:
providing information used to verify a user associated with a security device;
receiving at a local device from a security device a secure communication transmitted through a local connection of the local device, wherein content of the secure communication is inaccessible to the local device; and
forwarding, through an unsecured network, the secure communication to a remote secure device configured to access the content of the secure communication.

35. The method of claim 34, wherein the local connection comprises a peripheral connection to couple computer peripherals to the local device.

36. A system comprising:
a security information generator for determining information used to secure messages transmitted to a remote device;
a message generator for generating secure messages using the determined information; and
an interface to communicate with a peripheral interface of a host device configured to transmit the secure messages to the remote device, wherein content of the secured messages are inaccessible to the host device.

37. The system of claim 36, wherein the determined information comprises a session key.

38. The system of claim 37, wherein the message generator uses the session key for one of signing or encrypting messages.

39. A system comprising:
means for generating secure communications at a peripheral for transmission through an unsecured local device to a remote device; and
interface means for transmitting the secure communications to the unsecured local device, wherein content of the secure communications are inaccessible to the unsecured local device.

40. A method comprising:
generating information for securing communications between a security device and a remote device; and
transmitting the generated information to a host device using a peripheral connection, the host device coupled to the remote device without making the generated information accessible to the host device.
